(19) United States
(12) Patent Application Publication
(10) Pub. No.: US 2002/0180331 A1
(43) Pub. Date: Dec. 5, 2002

(54) Color cathode ray tube having improved color purity

(76) Inventor: Shinji Fukumoto, Mobara (JP)

Correspondence Address: Christopher E. Chalsen, Esq., Milbank, Tweed, Hadley & McCloy LLP, 1 Chase Manhattan Plaza, New York, NY, 10005-1413, US

(21) Appl. No.: 10/156,974

(22) Filed: May 29, 2002

(30) Foreign Application Priority Data
May 30, 2001 (JP) 2001-161784

(51) Int. Cl. H01J 29/50

(52) U.S. Cl. 313/409

(57) ABSTRACT

A color cathode ray tube includes a generally rectangular phosphor screen having a plurality of phosphor pixel line-trios each formed of three color phosphor pixels arranged in a line and a black matrix of opaque material having holes for defining areas of the phosphor pixels which are viewed through a panel, a shadow mask having a large number of mask apertures for color selection, and an electron gun. A distribution in area of center phosphor pixels of the phosphor pixel line-trios has sharp decreases, going from a center of the phosphor screen toward a periphery of the phosphor screen, in the vicinity of at least one of (a) top and bottom sides and (b) right and left sides, of a rectangular useful display area of the phosphor screen.

### BACKGROUND OF THE INVENTION

The present invention relates to a shadow mask type color cathode ray tube, and in particular, to a color cathode ray tube capable of displaying a high quality image with non-uniformity in color reduced by suppressing degradation in color purity due to the earth's magnetic field. Recently, shadow mask type color cathode ray tubes has been widely used displaying means for monitors of information equipment and color TV receivers. A flat-face-type which uses an approximately flat face panel as its viewing screen has become dominant among such color cathode ray tubes rapidly. The shadow mask type color cathode ray tube has a shadow mask suspended closely adjacent to an inner surface of the face panel, which serves as a color selection electrode.

One of requirements for a case where a color cathode ray tube is used for a monitor of a desktop type personal computer is reduction of the depth of the monitor. To fulfill this requirement, it is necessary to shorten the overall length of the color cathode ray tube, and therefore the so-called short-length color cathode ray tubes have been developed.

Especially in the flat-face-type color cathode ray tubes (the flat-face tube), the radius of curvature of the shadow mask (the color selection electrode) suspended closely adjacent to the inner surface of the panel is made extremely large to generally conform to the radius of curvature of the inner surface of the panel.

Landing errors of electron beams with respect to phosphor dots are increased at the peripheries of the viewing screen when the deflection angle is increased for shortening of the overall length in the flat-face-type color cathode ray tube. Consequently, a so-called wrong-color-striking (misregister) occurs in which electron beams exceed their intended phosphor dots and strike untended adjacent phosphor dots, and this causes degradation of color purity (reduction of color purity tolerance), resulting in pronounced deterioration of image quality.

One of measures against the degradation of color purity is to increase the width of guard bands (spacings between the adjacent phosphor dots) of the phosphor screen with increasing distance from the center of the viewing screen. This is carried out by optimizing the design of a correction lens and an exposure condition for exposing a photosensitive coating on the face panel through apertures in the shadow mask by actinic rays in a photographic phosphor-screen fabrication process, and optimizing the curvature of the shadow mask. Initially dot holes are made in portions of a photosensitive opaque black-matrix-forming coating illuminated by the actinic rays passing through the electron-beam-transmissive apertures in the shadow mask which serves as an exposure mask, and then the phosphor dots are obtained by filling different color phosphor materials in corresponding ones of the dot holes.

Usually, in such fabrication of the phosphor screen, a pattern of electron-beam-transmissive apertures in the shadow mask is transferred to a phosphor coating, and consequently, a distribution of sizes of phosphor dots (or sizes of dot holes is similar to that of sizes of the electron-beam-transmissive apertures in the shadow mask. Relevant conventional techniques are disclosed in Japanese Patent Application Laid-Open Nos. Hei 11-354,043 and 11-45,656, for example.

### SUMMARY OF THE INVENTION

It is a representative object of the present invention to provide a color cathode ray tube capable of securing greater color purity tolerance irrespective of its viewing screen by reducing the decrease in brightness and non-uniformity in display at the periphery of the viewing screen.

The following explains the representative ones of the present inventions disclosed in this specification briefly.

In accordance with an embodiment of the present invention, there is provided a color cathode ray tube comprising: a vacuum envelope including a panel, a neck, and a funnel connecting the panel and the neck; a generally rectangular phosphor screen comprising a plurality of phosphor pixel line-trios each formed of three color phosphor pixels arranged in a line and coated on an inner surface of the panel, and a black matrix of opaque material having holes for defining areas of the phosphor pixels which are viewed through the panel; a shadow mask having a large number of mask apertures for color selection and closely spaced from the phosphor screen; and an electron gun housed within the neck, wherein a distribution in area of center phosphor pixels of the phosphor pixel line-trios has sharp decreases, going from a center of the phosphor screen toward a periphery of the phosphor screen, in the vicinity of at least one of (a) top and bottom sides and (b) right and left sides, of a generally rectangular useful display area of the phosphor screen.

In accordance with another embodiment of the present invention, there is provided a color cathode ray tube comprising: a vacuum envelope including a panel, a neck, and a funnel connecting the panel and the neck; a generally rectangular phosphor screen comprising a plurality of phosphor pixel line-trios each formed of three color phosphor pixels arranged in a line and coated on an inner surface of the panel; a shadow mask having a generally rectangular apertured area formed with a large number of mask apertures for color selection and closely spaced from the phosphor screen; and an electron gun housed within the neck, wherein a distribution in area of the mask apertures has sharp decreases, going from a center of the apertured area toward a periphery of the apertured area, in the vicinity of at least one of (a) top and bottom sides and (b) right and left sides, of the apertured area.

The present invention is not limited to the above-described configurations or configurations of embodiments to be described subsequently, and it is needless to say that various changes and modifications can be made to the above configurations without departing from the nature and spirit of the present invention.

### BRIEF DESCRIPTION OF THE DRAWINGS

In the accompanying drawings, in which like reference numerals designate similar components throughout the figures, and in which:

FIG. 1 is a schematic plan view of a shadow mask for explaining an embodiment of a color cathode ray tube in accordance with the present invention;

FIG. 2 is an illustration of an example of an arrangement of electron-beam-transmissive apertures in the shadow mask shown in FIG. 1;

FIG. 3 is a schematic plan view of a phosphor screen for explaining an embodiment of a color cathode ray tube in accordance with the present invention;

FIG. 4 is an illustration of an example of an arrangement of phosphor pixel dots in the phosphor screen shown in FIG. 3;

FIG. 5 is a table for explaining an example of a distribution of diameters of electron-beam-transmissive apertures perforated in an apertured area of a shadow mask in one embodiment of the present invention;

FIG. 6 is an illustration for explaining a relationship between an arrangement of phosphor pixel dots and color purity tolerances in a color cathode ray tube having a useful phosphor screen diagonal dimension of 46 cm and a maximum deflection angle of 100 degrees;

FIG. 7 is an illustration for explaining a relationship between an arrangement of phosphor pixel dots and color purity tolerances in a color cathode ray tube having a useful phosphor screen diagonal dimension of 41 cm and a maximum deflection angle of 100 degrees;

FIG. 8 is a perspective view illustrating a shadow mask structure employed in a cathode ray tube in accordance with the present invention;

FIG. 9 is a schematic cross-sectional view illustrating an example of an overall structure of a color cathode ray tube in accordance with the present invention;

FIGS. 10A and 10B are schematic illustrations for explaining adjustment of color purity of a color cathode ray tube and degradation of color purity caused by the earth's magnetic field; and

FIG. 11 is an illustration of an example of displacement of electron beam spots on the phosphor screen caused by the influence of the earth's magnetic field, measured in the case explained in connection with FIGS. 10A and 10B.

### DETAILED DESCRIPTION

The above-described color purity tolerance can be increased by increasing the width of guard bands (spacings between the adjacent phosphor dots) of the phosphor screen. However, if the width of the guard bands is increased without changing the pitches of electron-beam-transmissive apertures in a shadowmask, the diameters of dot holes must be made smaller. If the diameters of the electron-beam-transmissive apertures in the shadow mask are made smaller with increasing distance from its center toward its periphery such that they are made smaller at the periphery where the influence of the earth's magnetic field is strong, the diameter of the dot holes can be made smaller at the periphery of the viewing screen. In this case, however, the amount of the electron beam passing through the electron-beam-transmissive apertures in the shadow mask is reduced at the periphery of the shadow mask where the diameters of the apertures are small, and consequently, according as the color purity tolerance is increased, brightness and uniformity in display is decreased.

Adjustment of color purity of a completed color cathode ray tube is carried out under an actual operating condition in which a deflection yoke, some magnetic beam-adjustment components and other devices mounted around the color cathode ray tube. If the orientation of the color cathode ray tube in actual operation is made different from that of the cathode ray tube when its color purity was adjusted, the landing positions of the electron beams on the phosphor dots are displaced from the indented positions due to the influence of the earth's magnetic field. Consequently, if the color purity tolerances are not sufficient, the electron beams strike phosphor dots other than the phosphor dots which they were intended to strike, resulting in degradation of color purity.

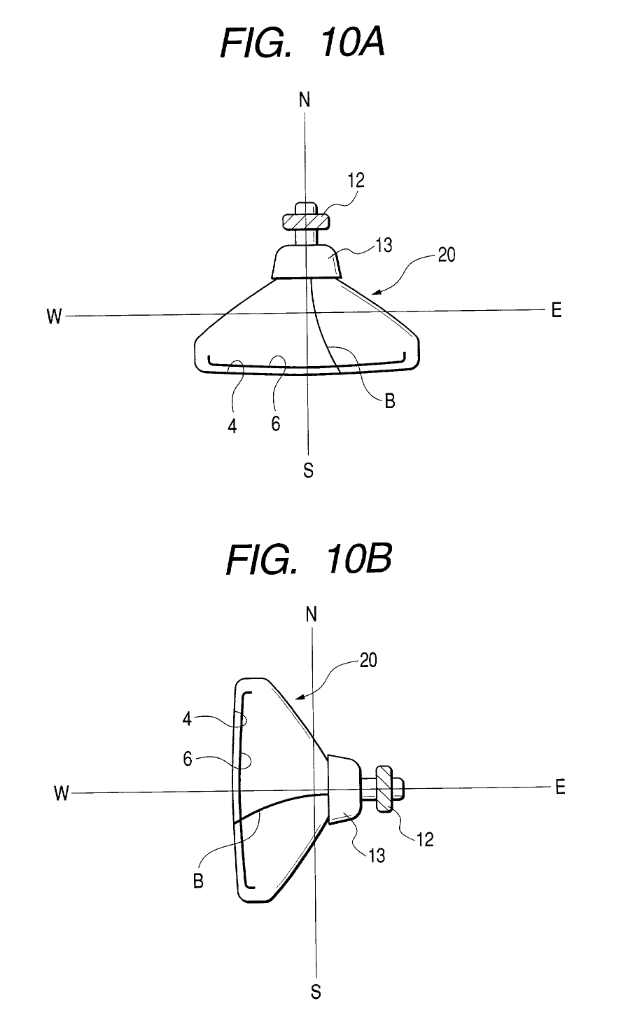

FIGS. 10A and 10B are schematic illustrations for explaining adjustment of color purity of the color cathode ray tube and degradation of the color purity caused by the earth's magnetic field. The color cathode ray tube 20 has a vacuum envelope composed of a panel, a neck and a funnel connecting the panel and the neck, a phosphor film 4 coated on an inner surface of the panel, and an electron gun housed within the neck. E electron beams B emitted from the electron gun pass through electron-beam-transmissive apertures in a shadow mask 6, and strike intended phosphor dots constituting the phosphor film 4. At this time the electron beams are deflected by a deflection yoke 13 to scan the phosphor film 4 horizontally and vertically and thereby form a two-dimensional image on the panel.

The adjustment of color purity of the completed color cathode ray tube is performed under an actual operating condition in which the deflection yoke 13 is mounted around the outside of a transition region between the funnel and the neck of the color cathode ray tube 20, and a magnetic beam-adjustment device 12 including a color-purity adjustment device, a beam-convergence adjustment device and the like are mounted around the outside of the neck housing the electron gun, as shown in FIG. 10A.

For example, initially the color purity was adjusted with the tube axis of the color cathode ray tube oriented in the north-south direction and with the panel (the viewing screen) facing the south as shown in FIG. 10A, and then if the tube axis of the cathode ray tube is oriented in the east-west direction as shown in FIG. 10B, the electron beams B impinge upon positions displaced from the phosphor dot positions struck by the electron beams when the color purity was adjusted, due to beam deflection by the earth's magnetic field. In this case, if the beam landing position is displaced such that the electron beams strike adjacent phosphor dots of wrong color (wrong-color-striking, or misregister), color contamination, i.e., degradation in color purity occurs, resulting in deterioration in image quality. This case causes the maximum degradation of color purity, and also in cases in which the orientation of the tube axis of the color cathode ray tube is changed to other directions from that in the case of FIG. 10A, the degradation in color purity occurs more or less.

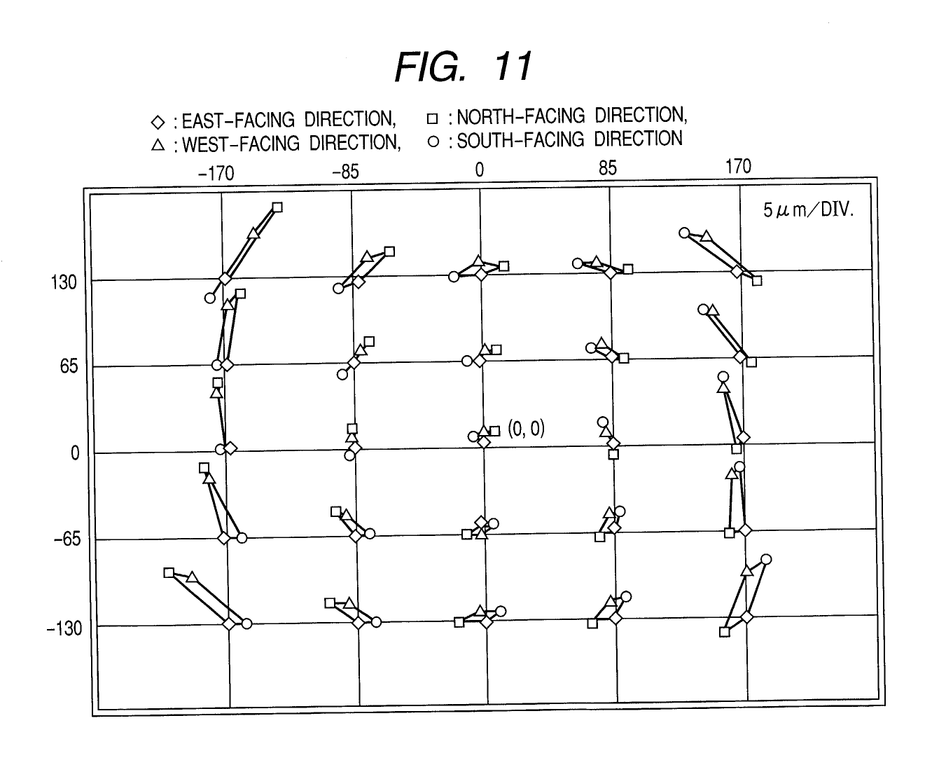

FIG. 11 is an illustration of an example of displacement of electron beams on the phosphor screen caused by the influence of the earth's magnetic field, measured in the case explained in connection with FIGS. 10A and 10B. FIG. 11 illustrates the influence of the earth's magnetic field in terms of movement of bright spots produced on the phosphor screen by impingement of the electron beams (hereinafter electron beam spots). In FIG. 11, the horizontal and vertical directions correspond to the horizontal and vertical scanning directions, respectively, with the center of the phosphor screen denoted by (0, 0).

In FIG. 11, circles denote positions of electron beam spots when color purity was adjusted with the tube axis of the color cathode ray tube oriented in the north-south direction and with its phosphor screen facing the south as shown in FIG. 10A, and for example, the electron beam spots move on the phosphor screen as indicated by rectangles, triangles and rhombuses when the phosphor screen was rotated successively to face the north, the west and the east from the condition in FIG. 10A, respectively. As is apparent from FIG. 11, the electron beam spots move greater distances at the periphery of the phosphor screen, and therefore if the color purity tolerances are greater at the periphery of the phosphor screen, the degradation of the color purity due to the wrong-color-striking (misregister) can be prevented.

Conventionally, a shadow mask having diameters on a large-diameter side of its electron-beam-transmissive apertures made progressively smaller from the center toward the periphery of the phosphor screen continuously or discontinuously was proposed by Japanese Patent Application Laid-Open No. Hei 11-354,043. Electron-beam-transmissive apertures in a shadow mask are formed such that diameters on its electron gun side are smaller than those in its phosphor screen side. In the shadow mask disclosed in the above-cited Japanese Patent Application Laid-Open No. Hei 11-354,043, large-diameters of the electron-beam-transmissive apertures on the phosphor screen side are made progressively smaller from the center toward the periphery of the phosphor screen.

The size of the electron-beam-transmissive apertures through which the electron beams can pass is determined by the size of the electron-beam-transmissive apertures on their small-diameter side. The invention disclosed in the above-cited Japanese Patent Application Laid-Open No. Hei 11-354,043 aims at preventing mechanical deformation in the so-called press-formed shadow mask (the shadow mask of the self-supporting, shape-self-maintaining, non-tension type), but not solving the problem of degradation of color purity caused by the influence of the earth's magnetic field.

Now the embodiments in accordance with the present invention will be explained in detail by reference to the drawings.

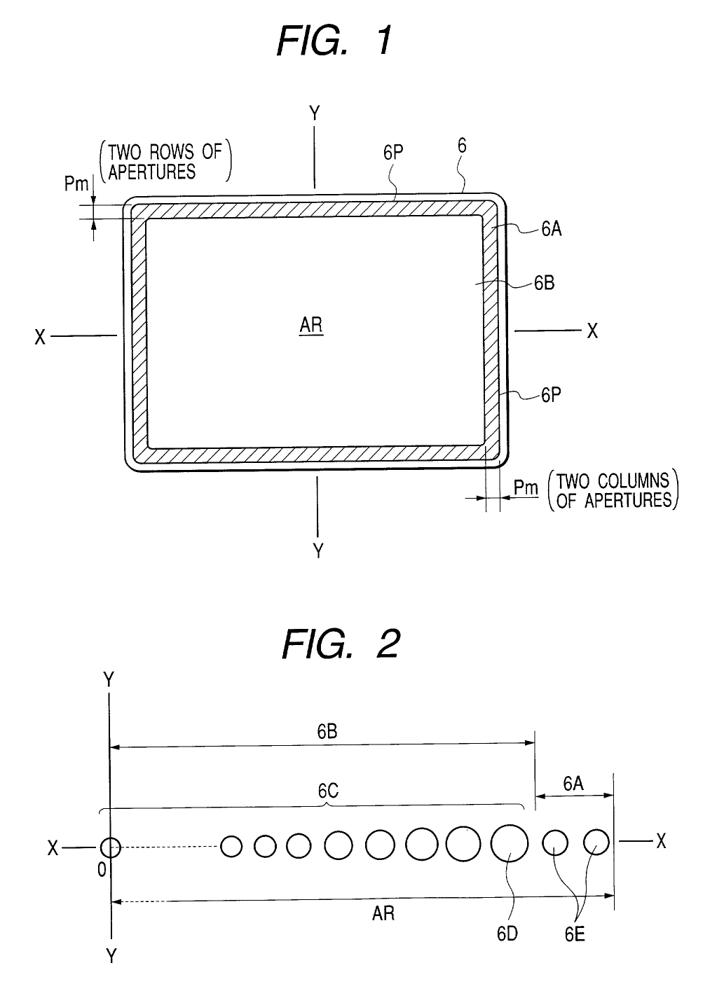

FIG. 1 is a schematic plan view of a shadow mask for explaining an embodiment of a color cathode ray tube in accordance with the present invention, and FIG. 2 is an illustration of an example of an arrangement of the electron-beam-transmissive apertures in the shadow mask shown in FIG. 1. FIG. 2 illustrates the arrangement of the electron-beam-transmissive apertures only in one line along the X axis in an apertured area AR in the shadow mask 6 of FIG. 1.

The shadow mask 6 of FIG. 1 has a large number of electron-beam-transmissive apertures (not shown) in its apertured area AR the periphery of which is indicated by solid lines 6P. The apertured area AR comprises a peripheral area 6A extending a specified distance Pm inwardly from the periphery 6P in parallel with the X and Y axes, respectively, of the apertured area AR, and a main area 6B surrounded by the peripheral area 6A. In FIG. 1, the peripheral area 6A is hatched. The diameter of the electron-beam-transmissive apertures 6E disposed in the peripheral area 6A is made smaller than the diameter of the electron-beam-transmissive aperture 6D at the outermost part of the main area 6B adjacent to the peripheral area 6A, looking toward the center O of the apertured area AR.

In FIGS. 1 and 2, the peripheral area 6A extends distances equal to two columns and two rows of the apertures along the X and Y axes, respectively, inwardly toward the center 0 from the periphery 6P of the apertured area AR, and the diameters of the electron-beam-transmissive apertures 6E in the peripheral area 6A are made smaller by approximately 5 μm than the diameters of electron-beam-transmissive apertures 6D at the outermost part of the main area 6B and adjacent to the apertures 6E, among the electron-beam-transmissive apertures 6C disposed in the main area 6B of the apertured area AR.

In this embodiment, the above-explained peripheral area 6A is provided on each of the long and short sides of the apertured area AR, and two rows and two columns of the electron-beam-transmissive apertures 6E are disposed along the X and Y axes, respectively, of the apertured area AR. However, in this embodiment, two columns of the electron-beam-transmissive apertures 6E can be disposed only on each of the short sides of the apertured area AR at outermost peripheral areas in the case of wide-angle deflection, in view of the aspect ratio of the phosphor screen, instead of disposing the above-described peripheral area 6A entirely around the periphery of the apertured area AR.

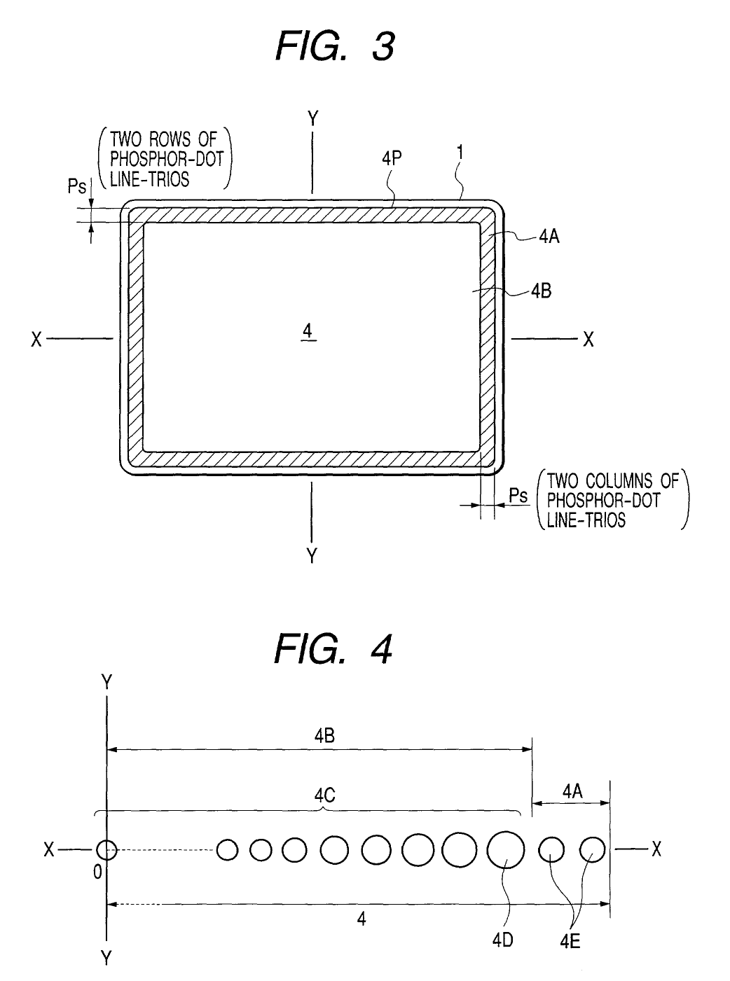

FIG. 3 is a schematic plan view of a phosphor screen for explaining an embodiment of a color cathode ray tube in accordance with the present invention, and FIG. 4 is an illustration of an example of an arrangement of phosphor pixel dots in the phosphor screen shown in FIG. 3. FIG. 4 illustrates the arrangement of the phosphor pixel dots only in one line along the X axis in the phosphor screen 4 of FIG. 3. The phosphor screen 4 composed of a large number of phosphor pixel dots is fabricated on the inner surface of the panel 1 by using the shadow mask 1 shown in FIG. 1 as a photomask in the photographic phosphor-screen fabrication process. The phosphor screen 4 serves as a useful display area of the viewing screen of the color cathode ray tube, and comprises a peripheral area 4A extending a specified distance Ps inwardly from the periphery 4P in parallel with the X and Y axes, respectively, of the apertured area AR, and a main area 4B surrounded by the peripheral area 4A. In FIG. 3, the peripheral area 4P is hatched. The diameter of the phosphor pixel dots 4E disposed in the peripheral area 4A is made smaller than the diameter of the phosphor pixel dot 4D at the outermost part of the main area 4B, among phosphor pixel dots 4C disposed in the main area 4B adjacent to the peripheral area 4A, looking toward the center O of the phosphor screen 4.

The phosphor pixel dots 4C and 4E shown in FIG. 4 show the dots disposed centrally in the arrangement of each of trios composed of three color phosphor pixel dots arranged in a line. In the actual arrangement of the phosphor pixel dots, two phosphor pixel dots of the remaining two colors are disposed on opposite sides of each of the centrally disposed phosphor pixel dots shown in FIG. 4, but they are omitted in FIG. 4. In this specification, the shapes and sizes of the phosphor pixel dots means the shapes and sizes defined by holes in a black matrix surrounding the phosphor pixel dots.

In FIGS. 3 and 4, the peripheral area 4A extends a distance equal to two columns of phosphor pixel dot trios each of which is composed of three color phosphor pixel dots (i.e., six columns of phosphor pixel dots) inwardly along the X axis toward the center O of the phosphor screen 4 from the periphery 4P, and also extends a distance equal to two rows of phosphor pixel dots inwardly along the Y axis toward the center O of the phosphor screen 4 from the periphery 4P. The diameters of the phosphor pixel dots 4E in the peripheral area 4A are made smaller by approximately 5 μm than the diameters of phosphor pixel dots 4D at the outermost part of the main area 4B and adjacent to the phosphor pixel dots 4E, looking toward the center O of the phosphor screen 4.

If the shapes of the electron-beam-transmissive apertures and the phosphor pixel dots defined by holes in a black matrix are not circular, elliptic, oval, or rectangular, for example, an average of their maximum and minimum diameters, or an area of the electron-beam-transmissive apertures and the phosphor pixel dots can be used instead of their diameters.

The boundary between the main area 6B and the peripheral area 6A of the apertured area AR of the shadow mask 6 is defined as a transition region where areas of the electron-beam-transmissive apertures decrease stepwise sharply, going from the center O of the apertured area AR toward its periphery 6P. Similarly, the boundary between the main area 4B and the peripheral area 4A of the phosphor screen 4 is defined as a transition region where areas of the phosphor pixel dots decrease stepwise sharply, going from the center O of the phosphor screen 4 toward its periphery 4P.

With this configuration, the cross-sectional area of electron beams impinging upon the phosphor pixel dots 4E disposed in the peripheral area 4A of the phosphor screen 4 of FIG. 3 corresponding to the peripheral area 6A of the shadow mask 6 of FIG. 1 are made smaller than that of electron beams impinging upon the phosphor pixel dots 4D disposed at the outermost parts of the main area 4B adjacent to the peripheral area 4A, looking toward the center 0 of the useful display area (the phosphor screen 4). Consequently, the peripheral area 4A is reduced in brightness and dark in the form of a band in theory when the entire viewing screen displays a scene of a given color or a white scene.

However, in a case in which the reduction in brightness occurs only in the phosphor pixel dots 4E of two trio-rows and two trio-columns in the peripheral area 4A around the useful display area (the phosphor screen 4), even if the diameters of the phosphor pixel dots 4E are made smaller by 5 μm or so than those of the phosphor pixel dots 4D at the periphery of the main area 4B, resultant visual discomfort is practically acceptable.

If the sum (2×Ps) of the two lengths (Ps) at the peripheral area 4A of the phosphor screen 4 in a direction of each of the X and Y axes is equal to or smaller than 2% of a length of the useful display area of the phosphor screen 4 measured on a corresponding one of the X and Y axes, visual influences caused by brightness reduction at the peripheral regions of the viewing screen of a cathode ray tube are acceptable in actual usage of a monitor or a TV receiver set. Therefore, also in the shadow mask 6 associated with the phosphor screen 4, if the sum (2×Pm) of the two lengths (Pm) at the peripheral area 6A in a direction of each of the X and Y axes is equal to or smaller than 2% of a length of the apertured area AR of the shadow mask 6 measured on a corresponding one of the X and Y axes, the visual influences caused by brightness reduction at the peripheral regions are acceptable.

The following explains an example of a distribution of diameters of the electron-beam-transmissive apertures 6C perforated in the main area 6B of the apertured area AR of the shadow mask 6, including the electron-beam-transmissive apertures 6D at the outermost parts of the main area 6B. As shown in FIG. 2, the distribution of diameters of the electron-beam-transmissive apertures 6C in the main area 6B can be selected such that the diameters of the electron-beam-transmissive apertures 6C are made progressively larger from the center 0 of the apertured area toward the peripheral area of the apertured area, or such that the diameters of the electron-beam-transmissive apertures 6C are made approximately uniform from the center O of the apertured area to its intermediate portion and then they are made progressively larger from the intermediate portion toward the peripheral area of the apertured area. It is effective for reducing the decrease in brightness at the peripheral regions at the viewing screen to select the distribution of diameters of the electron-beam-transmissive apertures 6C in the main area 6B occupying a major portion of the apertured area AR excluding the peripheral area 6A such that the diameters of the electron-beam-transmissive apertures 6C are progressively larger from the center O of the apertured area toward the peripheral area of the apertured area.

Especially in a cathode ray tube employing a face panel having a glass thickness in a direction of its tube axis at corners of the useful display area two times or more greater than the glass thickness at its center of the useful display area, light transmission through the face panel is reduced greatly at the peripheral regions of the viewing screen. In a cathode ray tube employing a face panel having such a thick wedge-shaped cross-section at its peripheral regions, if the distribution of diameters of the electron-beam-transmissive apertures in the main area of the shadow mask is selected such that the ratio in area of the electron-beam-transmissive apertures at the periphery of the main area 6B of the shadow mask 6 to the electron-beam-transmissive aperture at the center of the main area 6B is equal to or more than 1.02, the area of each of the phosphor pixel dots is increased at the peripheral regions of the viewing screen, and consequently, uniformity of brightness is improved over the entire viewing screen.

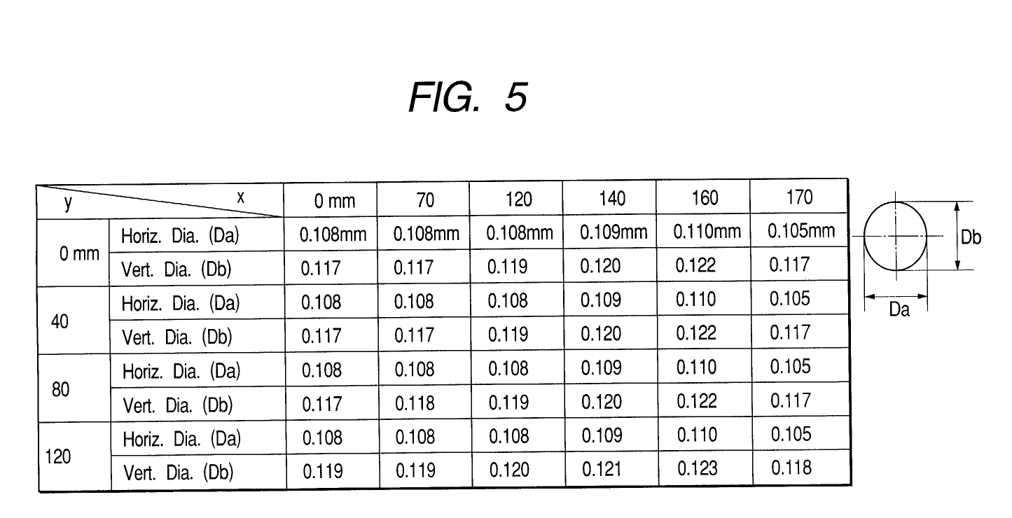

FIG. 5 is a table for explaining an example of a distribution of diameters of the electron-beam-transmissive apertures perforated in the apertured area of the shadow mask in this embodiment, where Da (mm) and Db (mm) denote horizontal and vertical diameters of the electron-beam-transmissive apertures, respectively. In the shadow mask of the cathode ray tube of this embodiment, the center O of the apertured area AR is at x=0 mm, y=0 mm, and one corner of the aperture area AR is at x=170 mm, y=120 mm. In the table of FIG. 5, the small-diameter electron-beam-transmissive apertures 6E disposed in the peripheral 6A of the apertured area 6A are at x=170 mm along the short side of the apertured area AR shown in FIGS. 1 and 2, and the electron-beam-transmissive apertures 6C disposed in the main area 6B are located at the remaining positions.

As indicated in the table of FIG. 5, the horizontal and vertical diameters of each of the electron-beam-transmissive apertures disposed at the short sides of the apertured area AR (at x=170 mm) are smaller by 5 μm than those of a corresponding one of the electron-beam-transmissive apertures disposed at peripheral positions (at x=160 mm) displaced inwardly by 10 mm from the short side of the apertured area AR, respectively, and the diameters of the electron-beam-transmissive apertures increase gradually in the area extending from the center (x=0, y=0) to the peripheral positions (x=160 mm).

This embodiment increases the color purity tolerances at the peripheral area of the viewing screen and consequently, is capable of preventing occurrence of the wrong-color-striking (misregister) due to landing errors of the electron beams caused by the earth's magnetic field explained in connection with FIGS. 10A and 10B. Further, since the phosphor dots at the peripheral regions of the main area are larger than those at the central region of the main area, and consequently, reduction in brightness and non-uniformity of display at the peripheral regions are decreased such that high-quality image is obtained. Especially, if the ratio in area of phosphor dots at the peripheral regions to those at the central region is selected to be 1.02 or more, it is effective for color cathode ray tubes whose brightness decreases at the peripheral regions of its viewing screen such as cathode ray tubes of the flat-face type whose average radius of curvature of its external panel surface along the major axis of the useful display area is equal to or more than 10,000 mm, and whose average radius of curvature of its internal panel surface along the major axis of the useful display area is equal to or less than 3,000 mm, for example.

In the above embodiment, the diameters of the electron-beam-transmissive apertures disposed at the short sides of the apertured area AR are selected to be smaller by 5 μm than those of the electron-beam-transmissive apertures disposed at peripheral positions of the main area of the apertured area AR, but, in a case where distortion of the shape of the electron beam spots is comparatively small, the similar advantages are obtained even if the above difference in diameter between the electron-beam-transmissive apertures are selected to be in a range from 2 μm to 3 μm.

If the ratio in area of an electron-beam-transmissive aperture (or a phosphor pixel dot associated with this aperture) disposed in the peripheral region to an electron-beam-transmissive aperture (or a phosphor pixel dot associated with this aperture) disposed at the periphery of the main area is in a range from 0.85 to 0.98, occurrence of the wrong-color-striking by electron beams (misregister) at the periphery of the viewing screen is suppressed even in the case of cathode ray tubes having a maximum deflection angle equal to or larger than 90 degrees. Further, if the above-explained ratio is in a range from 0.85 to 0.96, occurrence of the wrong-color-striking by electron beams (misregister) at the periphery of the viewing screen is suppressed even in the case of cathode ray tubes having a maximum deflection angle equal to or larger than 95 degrees.

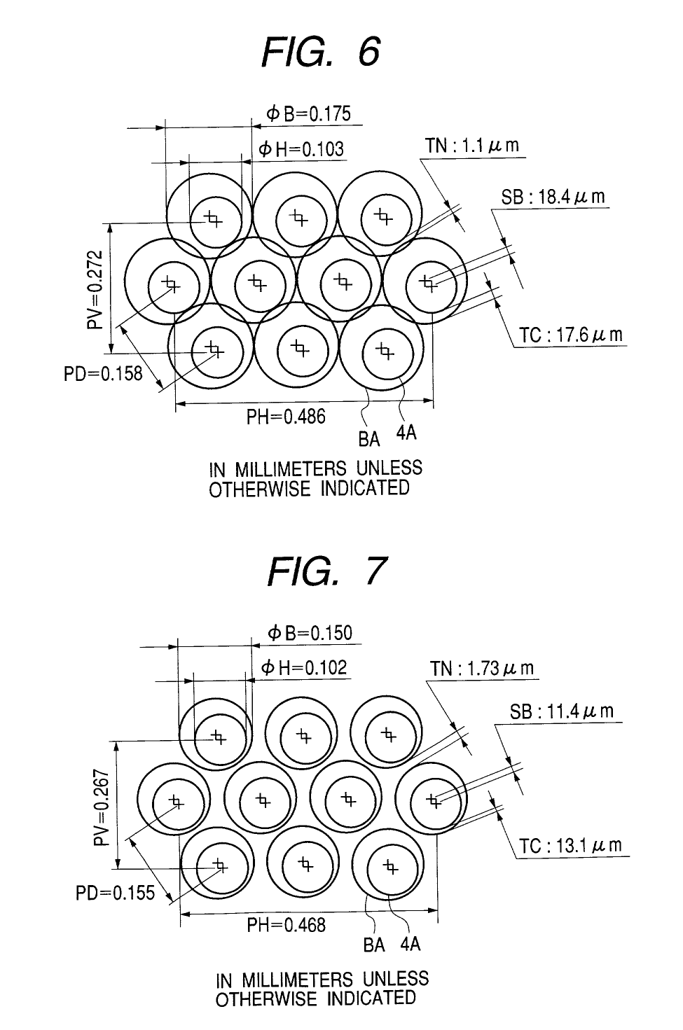

FIG. 6 is an illustration for explaining the relationship between the arrangement of phosphor pixel dots and color purity tolerances in a color cathode ray tube having a useful phosphor screen diagonal dimension of 46 cm and a maximum deflection angle of 100 degrees, and FIG. 7 is an illustration for explaining the relationship between the arrangement of phosphor pixel dots and color purity tolerances in a color cathode ray tube having a useful phosphor screen diagonal dimension of 41 cm and a maximum deflection angle of 100 degrees. The following explains the relationships at corners of the phosphor screen composed of circular phosphor pixel dots.

The notation in FIGS. 6 and 7 is as follows:

ØB (mm)=a diameter of an electron beam spot;

ØH (mm)=a diameter of a phosphor pixel dot defined by a hole perforated in a black matrix surrounding phosphor pixel dots;

PH (mm)=a horizontal pitch between phosphor pixel dots of the same color defined by the holes in the black matrix;

PV (mm)=a vertical pitch between phosphor pixel dots of the same color defined by the holes in the black matrix;

PD (mm)=a pitch between adjacent phosphor pixel dots defined by the holes in the black matrix;

SB (μm)=a shift of an electron beam spot between north and south facing orientations by the influence of the earth's magnetic field;

TC (μm)=a chipping tolerance defined as a maximum distance the electron beam spot can move before it does not illuminate part of an intended phosphor pixel dot; and

TN (μm)=a wrong-color-striking tolerance defined as a distance the electron beam spot can move before it strikes an adjacent phosphor pixel dot of a wrong color.

In the case of the color cathode ray tube having the useful phosphor screen diagonal dimension of 46 cm shown in FIG. 6,

ØB=0.175 mm,

ØH=0.103 mm,

PH=0.486 mm,

PV=0.272 mm,

PD=0.158 mm,

SB=18.4 μm,

TC=17.6 μm, and

TN=1.1 μm.

In the case of the color cathode ray tube having the useful phosphor screen diagonal dimension of 41 cm shown in FIG. 7,

ØB=0.150 mm,

ØH=0.102 mm,

PH=0.468 mm,

PV=0.267 mm,

PD=0.155 mm,

SB=11.4 μm,

TC=13.1 μm, and

TN=17.3 μm.

As is apparent from the comparison between the above two color cathode ray tubes having the useful phosphor screen diagonal dimensions of 46 and 41 cm, respectively, the wrong-color-striking tolerance TN of the color cathode ray tube having the useful phosphor screen diagonal dimension of 46 cm is smaller than that of the color cathode ray tube having the useful phosphor screen diagonal dimension of 41 cm. In the color cathode ray tube having the useful phosphor screen diagonal dimension of 46 cm, a transverse cross section of a portion of a funnel of its vacuum envelope around which a deflection yoke is mounted is made approximately rectangular so as to improve deflection sensitivity of electron beams with a view to reduction of lower power consumption. On the other hand, in the case of the color cathode ray tube having the useful phosphor screen diagonal dimension of 41 cm, the transverse cross section of the yoke-mounting portion of its funnel is circular. Both the diameters of the cross section of the yoke-mounting portion of the rectangular funnel measured on the horizontal (X) and vertical (Y) axes, respectively, are smaller than those of the circular funnel. In the case of the 46 cm-diagonal-screen color cathode ray tube, since the angle of incidence of electron beams at the peripheral areas of the phosphor screen becomes somewhat larger, the diameter ØB of the electron beam spots is increased, and consequently, the chipping tolerance TN is decreased. Therefore, in color cathode ray tubes of the type employing the above-mentioned rectangular funnel, it is necessary to increase the wrong-color-striking tolerance TN in the peripheral area of the useful display area.

In this embodiment, the wrong-color-striking tolerance TN was increased to 6.1 μm by making the diameters of the phosphor pixel dots at the peripheral area of the useful display area smaller by approximately 5 μm than those of the phosphor pixel dots at the periphery of the main area of the useful display area. With this configuration, the color purity tolerances in the vicinity of corners of the viewing screen are increased, and consequently, the wrong-color-striking due to landing errors of electron beam caused by the earth's magnetic field is prevented. Since the diameters of the phosphor pixel dots at the peripheral regions of the main area are larger than those of the phosphor pixel dots at the central portion of the main area, reduction in brightness and non-uniformity of display at the peripheral regions of the viewing screen are decreased such that high-quality images are obtained. This means that, if the above configuration is applied to the 41 cm-diagonal-screen color cathode ray tube shown in FIG. 7, the color purity tolerances in the vicinity of corners of the viewing screen are increased still more. In this case, the similar advantages are obtained by making the diameters of the phosphor pixel dots at the peripheral area of the useful display area smaller by a value in a range from about 2 to about 3 μm than those of the phosphor pixel dots at the periphery of the main area of the useful display area.

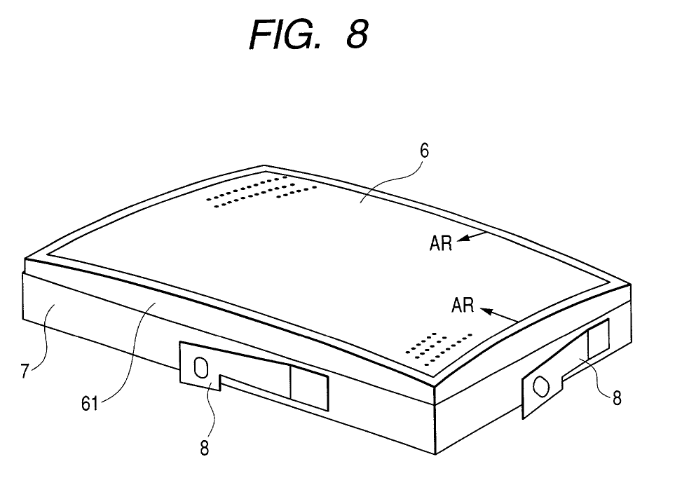

FIG. 8 is a perspective view illustrating a shadow mask structure employed in a cathode ray tube in accordance with the present invention. As shown in FIG. 8, the shadow mask structure has the apertured area AR serving as a principal area of a shadow mask 6 and curved to conform to the curvature of an inner surface of the face panel described subsequently, and a skirt portion 61 bent approximately in a direction of the tube axis welded to a mask frame 7 to which attached are suspension springs 8 to be engaged with studs embedded in an inner wall of a skirt portion of the face panel. Dot holes (BM dot holes) are perforated in a black matrix film by using the shadow mask 6, and then the phosphor screen is fabricated by filling the dot holes with corresponding color phosphors.

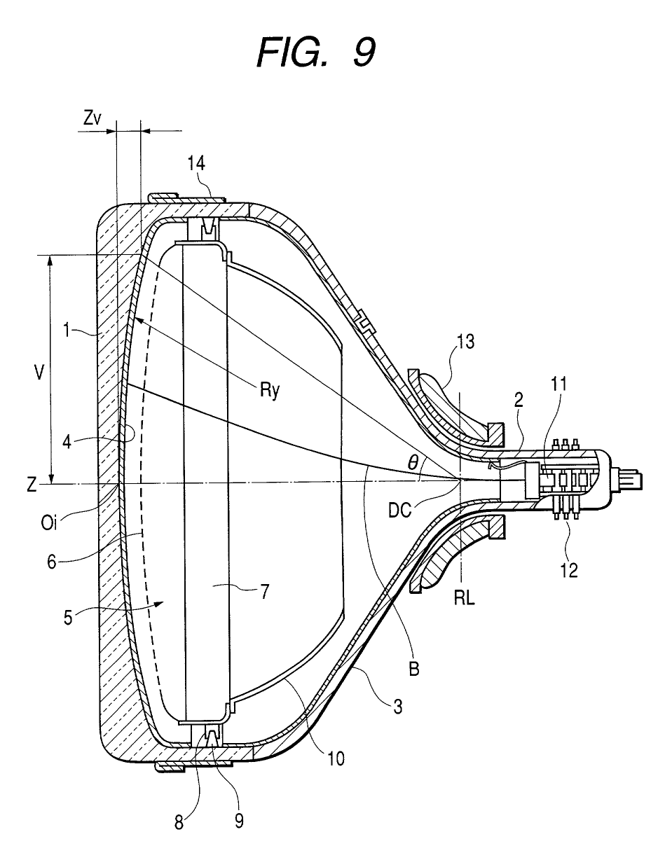

FIG. 9 is a schematic cross-sectional view illustrating an example of an overall structure of a color cathode ray tube in accordance with the present invention. This color cathode ray tube comprises a vacuum envelope composed of a panel (a face panel) 1, a neck 2, and a generally truncated-cone-shaped funnel 3 connecting the panel 1 and the neck 2, a phosphor screen 4 composed of phosphors of plural colors coated on an inner surface of the panel 1, an electron gun 11 housed within the neck 2.

Coated on the inner surface of the panel 1 is the phosphor screen 4 formed of trios each composed of three color phosphor pixel dots arranged in a horizontal line, and closely spaced from the phosphor screen 4 is the shadow mask 6 having a large number of apertures therein for color selection. Reference numeral 5 denotes a shadow mask structure comprising the shadow mask 6 formed with a large number of electron-beam-transmissive apertures made by etching and a mask frame 7 to which the shadow mask 6 is welded.

The mask frame 7 has a magnetic shield 10 fixed to its electron-gun-side end and is suspended by studs 9 embedded in an inner wall of a skirt portion of the panel 1 via suspension springs 8. The inner surface of the panel 1 is curved with a curvature considerably greater than that of its external surface.

In general, the curvature of the inner surface of the panel is represented by the following equation:

Zi=A1 x²+A2 x⁴+A3 y²+A4 y⁴+A5 x²y²+A6 x ²y⁴+A7 x⁴y²+A8 x⁴y⁴,

where

A1 to A8=coefficients,

the rectangular co-ordinate axes are drawn on the front view of the phosphor screen 4 (the generally rectangular useful display area) fabricated on the inner surface of the panel 1 so that the origin is located at the center Oi of the phosphor screen 4, the x and y axes are oriented in directions of major and minor axes of the phosphor screen 4, respectively, and the z axis (the tube axis) directed toward the cathode is perpendicular to the x-y plane, and passes through the center Oi, and

Zi=a distance of a point (x, y) of the inner surface of the panel 1 from the center Oi of the inner surface.

The desired curvature of the inner surface is obtained by determining the coefficients A1 to A8 in the above equation.

The curvatures of the outer surface of the panel 1 and the apertured area of the shadow mask 6 are also determined as in the case of the inner surface of the panel 1.

The curvature determined by the above equation is often aspherical, and therefore radiuses of curvature vary with positions on the inner surface. Therefore the radius of curvature of the inner surface of a panel can be defined by using the average radius of curvature as calculated below.

Ry=(Zv²+V²)/(2Zv),

where Ry (mm)=the average radius of curvature along the minor axis (the y axis) in the useful display area,

V (mm)=a distance from the z axis to the end of the useful display area in the direction of the y axis, and

Zv (mm)=a distance from the x-y plane containing the center Oi to the end of the useful display area in the direction of the y axis.

The above average radius of curvature is defined by using the values in connection with the minor axis (the y axis) of the inner surface of the panel, but the average radius of curvature can also be defined by using the values in connection with the major axis (the x axis) or the diagonal of the inner surface of the panel. Further, the average radiuses of curvature of the outer surface of the panel 1 and the apertured area of the shadow mask 6 can be defined similarly.

A deflection yoke 13 is mounted around the outside of the neck 2 side of the funnel 3, and deflects three electron beams B (only one of which is shown) emitted from an electron gun 11 in horizontal and vertical directions so as to produce an image on the phosphor screen 4. Reference numeral 12 denotes a magnetic correction device for adjusting color purity, beam convergence, and others, 14 is an implosion protection band.

A reference line RL serving as a reference in the design of cathode ray tubes is established at a position displaced toward the panel 1 from the sealing line between the neck 2 and the funnel 3 in the portion of the funnel 3 mounting the deflection yoke 13, and the intersection of the reference line RL with the tube axis Z is called the deflection center DC. A deflection angle θ is defined as an angle formed between the tube axis Z and a line connecting the deflection center DC and an arbitrary point on the inner surface of the panel 1 the electron beam B strikes. Here the maximum deflection angle of a cathode ray tube is twice the angle θmax formed between the tube axis Z and a line connecting the deflection center DC and one corner of the useful display area of the inner surface of the panel 1, i.e., the end of the diagonal of the useful display area.

As explained above, with representative configurations of the present invention, the color purity tolerance at the peripheral area is increased, and consequently, this prevents occurrence of wrong-color-striking due to landing errors of electron beams caused by the earth's magnetic field, and reduction in brightness and non-uniformity in display at peripheral regions of the viewing screen are decreased such that high-quality images are obtained.

What is claimed is:

1. A color cathode ray tube comprising:
a vacuum envelope including a panel, a neck, and a funnel connecting said panel and said neck;
a generally rectangular phosphor screen comprising a plurality of phosphor pixel line-trios each formed of three color phosphor pixels arranged in a line and coated on an inner surface of said panel, and a black matrix of opaque material having holes for defining areas of said phosphor pixels which are viewed through said panel;
a shadow mask having a large number of mask apertures for color selection and closely spaced from said phosphor screen; and
an electron gun housed within said neck,
wherein a distribution in area of center phosphor pixels of said phosphor pixel line-trios has sharp decreases, going from a center of said phosphor screen toward a periphery of said phosphor screen, in the vicinity of at least one of (a) top and bottom sides and (b) right and left sides, of a generally rectangular useful display area of said phosphor screen.

2. A color cathode ray tube according to claim 1, wherein
said distribution in area of center phosphor pixels of said phosphor pixel line-trios has said sharp decrease at distances from at least one of (a) said top and bottom sides and (b) said right and left sides,
a total of said distances from (a) said top and bottom sides, respectively, is in a range from 0.2% to 5% of a distance between said top and bottom sides, and
a total of said distances from (b) said right and left sides, respectively, is in a range from 0.2% to 5% of a distance between said right and left sides.

3. A color cathode ray tube according to claim 1, wherein said sharp decreases are in a range from 2% to 15% of areas of corresponding ones of said center phosphor pixels immediately before said sharp decreases.

4. A color cathode ray tube according to claim 1, wherein areas of corresponding ones of said center phosphor pixels immediately before said sharp decreases are larger than an area of a center phosphor pixel of one of said plurality of said phosphor pixel line-trios at a center of said useful display area of said phosphor screen.

5. A color cathode ray tube according to claim 4, wherein said areas of corresponding ones of said center phosphor pixels immediately before said sharp decreases are in a range from 102% to 105% of said area of said center phosphor pixel of said one of said plurality of said phosphor pixel line-trios at the center of said useful display area of said phosphor screen.

6. A color cathode ray tube according to claim 1, wherein areas of corresponding ones of said center phosphor pixels immediately before said sharp decreases are approximately equal to an area of a center phosphor pixel of one of said plurality of said phosphor pixel line-trios at the center of said useful display area of said phosphor screen.

7. A color cathode ray tube according to claim 1, wherein said phosphor pixels are circular dots in shape.

8. A color cathode ray tube according to claim 1, wherein said phosphor pixels are non-circular dots in shape.

9. A color cathode ray tube comprising:
a vacuum envelope including a panel, a neck, and a funnel connecting said panel and said neck;
a generally rectangular phosphor screen comprising a plurality of phosphor pixel line-trios each formed of three color phosphor pixels arranged in a line and coated on an inner surface of said panel;
a shadow mask having a generally rectangular apertured area formed with a large number of mask apertures for color selection and closely spaced from said phosphor screen; and
an electron gun housed within said neck,
wherein a distribution in area of said mask apertures has sharp decreases, going from a center of said apertured area toward a periphery of said apertured area, in the vicinity of at least one of (a) top and bottom sides and (b) right and left sides, of said apertured area.

10. A color cathode ray tube according to claim 9, wherein
said distribution in area of mask apertures has said sharp decrease at distances from at least one of (a) said top and bottom sides and (b) said right and left sides, of said apertured area,
a total of said distances from (a) said top and bottom sides, respectively, is in a range from 0.2% to 5% of a distance between said top and bottom sides, and
a total of said distances from (b) said right and left sides, respectively, is in a range from 0.2% to 5% of a distance between said right and left sides.

11. A color cathode ray tube according to claim 9, wherein said sharp decreases are in a range from 2% to 15% of areas of corresponding ones of said mask apertures immediately before said sharp decreases.

12. A color cathode ray tube according to claim 9, wherein areas of corresponding ones of said mask apertures immediately before said sharp decreases are larger than an area of one of said large number of mask apertures at a center of said apertured area of said shadow mask.

13. A color cathode ray tube according to claim 12, wherein said areas of corresponding ones of said large number of mask apertures immediately before said sharp decreases are in a range from 102% to 105% of said area of said one of said large number of mask apertures at the center of said apertured area of said shadow mask.

14. A color cathode ray tube according to claim 9, wherein areas of corresponding ones of said large number of mask apertures immediately before said sharp decreases are approximately equal to an area of one of said large number of mask apertures at the center of said apertured area of said shadow mask.

15. A color cathode ray tube according to claim 9, wherein said mask apertures are circular.

16. A color cathode ray tube according to claim 9, wherein said mask apertures are non-circular.
